(19) United States
(12) Patent Application Publication
(10) Pub. No.: US 2005/0042496 A1
(43) Pub. Date: Feb. 24, 2005

(54) Method for manufacturing fuel cell separator plates under low shear strain

(76) Inventors: Mukesh K Bisara, Ontario (CA); Yuqi Cai, Ontario, Kingston (CA); Divya Chopra, Kingston (CA); Alistair N Mollison, Oakville (CA); John Charles Fisher, Kingston (CA)

Correspondence Address: Daphine P Fickes;E.I. Du Pont Canada Company, Legal - Patents, Wilmington, DE, 19898, US

(21) Appl. No.: 10/503,284

(22) PCT Filed: Feb. 13, 2003
(86) PCT No.: PCT/CA03/00202

Related U.S. Application Data
(60) Provisional application No. 60/357,037, filed on Feb. 13, 2002.

(51) Int. Cl. H01M 8/02; H01B 1/24

(52) U.S. Cl. 429/38; 252/511; 264/104; 264/105

(57) ABSTRACT

An improved process for fabricating an electrically conductive shaped article is disclosed. The process includes one or more process stages selected from the group consisting of: preparing one or more feeds of the plastic and fillers; feeding the plastic and fillers to a melt compounding stage wherein a homogeneous melt of the composition is obtained; transferring the homogeneous melt ; and subjecting the homogeneous melt to a moulding process to produce the conductive shaped article. One or more of the process stages is conducted under low shear strain conditions so that the article has a through-plane resistivity of less than about 600 μOhm-m. Also disclosed are the conductive plates having improved performance properties such as flexural strength, conductivity and surface smoothness.

### FIELD OF THE INVENTION

This invention relates to improved methods for manufacturing electrically conductive polymer composite shaped articles for use in electronic, thermoelectric and electrochemical devices. In particular, the invention relates to a method for making highly electrically conductive polymer composites, conductive plates, also called collector plates or flow field plates or separator plates or bipolar plates, which can be used in highly corrosive environments such as those found in fuel cells. Also disclosed are the conductive plates having improved performance properties such as flexural strength, conductivity and surface smoothness.

### BACKGROUND OF THE INVENTION

The cost of fuel cells must be reduced dramatically to become commercially viable on a larger scale. The cost of the flow field plates, including the cost of forming the flow field onto the plate, represents a significant portion of the total cost within a fuel cell. Therefore, cost reduction of the flow field plate is imperative to enable fuel cells to become commercially viable on a larger scale. The cost reduction can be manifested in several ways including reducing the cost of the materials that are used to make the plate, reducing the manufacturing cost associated with making the plate, and/or improving the function/performance of the plate within a fuel cell so that the same fuel cell can produce electrical power more efficiently and/or produce more electrical power within the same fuel cell. Typically, developments in the flow field plate have attempted to optimize the trade-offs by reducing material cost and/or manufacturing cost while compromising performance-in-use.

A typical Polymer-Electrolyte-Membrane (PEM) fuel cell comprises several components. These components typically include a membrane, catalyst layers on the anode and cathode sides of the membrane known as the gas diffusion electrodes, and gas diffusion backings on each side. The membrane, electrode layers and gas diffusion backings are laminated together to create the membrane electrode assembly (MEA). Each MEA is sealed between two thermally and electrically conducting flow field plates. The seals are typically provided by silicone or some elastomer material, such as VITON®. Each cell is then “stacked” with other cells to achieve the required voltage and power output to form a fuel cell stack. Each stack is subjected to a compressive load to ensure good electrical contact between individual cells.

In operation, fuel is introduced on the anode side of the cell through flow field channels in the conductive flow field plates. The channels uniformly distribute fuel across the active area of the cell. The fuel then passes through the gas diffusion backings (GDB) of the anode and travels to the anode catalyst layer. Air or oxygen is introduced on the cathode side of the cell, which travels through the GDB of the cathode to the cathode catalyst layer. Both catalyst layers are porous structures that contain precious metal catalysts, carbon particles, ion-conducting NAFION® particles, and, in some cases, specially engineered hydrophobic and hydrophilic regions. At the anode side, the fuel is electrochemically oxidised to produce protons and electrons. The protons must travel from anode side, across the ion-conducting electrolyte membrane, finally to the cathode side in order to react with the oxygen at the cathode catalyst sites. The electrons produced at the anode side must be conducted through the electrically conducting porous GDB to the conducting flow field plates. As soon as the flow field plate at the anode is connected with the flow field plate at the cathode via an external circuit, the electrons will flow from the anode through the circuit to the cathode. The oxygen at the cathode side will combine protons and electrons to form water as the by-product of the electrochemical reaction. The by-products must be continually removed via the flow field plate at the cathode side in order to sustain efficient operation of the cell. Water is the only by-product if hydrogen is used as the fuel while water and carbon dioxide are the by-products if methanol is used as the fuel.

Flow field plates are the outer components in each cell and are contacting the electrodes, typically directly in contact with the GDB layer. The flow field plates provide many functions that place unusual demands on the materials of construction. The plates have channels formed in their surface called “flow fields”. Flow fields are precision-engineered fluid flow channels that are designed to optimise fluid flow and fuel cell performance characteristics. Dramatic gains in kW/m² power density achieved over the last ten years are due in large part to improved flow field design. The plates conduct electrons and heat during a fuel cell operation. Both electrical and thermal conductivity must be maintained over a long, operating life in a highly demanding operating environment. Since electrical resistance will convert part of the electrical power produced in the fuel cell to heat and cause power losses, electrical resistance of the plates needs to be minimised for high power output of a fuel cell. The bulk resistivity of the plate material, the thickness of the plate and the surface contact resistance between the GDB and the plate are the major factors contributing the electrical losses. Less thick plates of the same resistivity will reduce electrical resistance losses. It is believed that the ductility of the plate surface and the topology of the surface will affect contact resistance.

The plates provide mechanical integrity to the overall cell and stack. Mechanical integrity includes the maintenance of fluid seals within each cell and cell-to-cell, the maintenance of uniform electrical contact within each cell's active area and cell-cell within a stack; and the maintenance of a physical barrier between oxidant and fuel in a fuel cell stack. These functions are necessary to ensure safe operation of the fuel cell.

In some hydrogen-based PEM fuel cell designs, the conductive flow field plates also act as “water transport plates”. The NAFION membranes need water to function. These water transport plates are made permeable to water and relatively impermeable to hydrogen and air. Water produced at the cathode side of the cell gets transported through the plate to the anode side of the next cell in a bipolar stack design. The internally-produced water is used on the anode side to humidify the membrane. This approach eliminates the need for a separate membrane humidification subsystem, thereby simplifying the balance-of-plant requirements.

Flow field plates play a key role in the management of heat within a fuel cell stack, as well. Significant amounts of heat are generated along with electricity during normal fuel cell operation. The heat is removed from the stack first through conduction from the active electrode through the plate, then by convection from the plate to the air or cooling water. At times, internal cooling water channels are formed within the plate, between adjacent plates, or with the addition of additional cooling cells within a stack.

The material options for plates have been severely limited due to the aggressive conditions inside the PEM fuel cell and the unique set of performance requirements in the PEM fuel cells. Direct methanol, direct hydrogen, and reformmate hydrogen PEM fuel cells all present an aggressive operating environment for the flow field plate that make operating life considerations for materials paramount.

Because of the multifunctional role of the flow field plate in a fuel cell, the flow field plate material has a number of requirements to meet. It must have good electrical and thermal conductivity, good mechanical or structural properties, good gas barrier properties and high chemical stability in the chemically reactive fuel cell environment.

Graphite and gold plated metal alloys, such as stainless steel and aluminium, have been the materials of the flow field plates that are traditionally used in PEM fuel cells. However, these materials, plus the additional cost associated with fabricating the flow field, are quite costly.

Carbon/graphite composites made with plastic polymers have long been identified as a promising alternative to traditional materials in flow field plates. In U.S. Pat. No. 4,339,322 to Balks et al, there is disclosed a bipolar current collector plate for electrochemical cells comprising a moulded aggregate of graphite and a thermoplastic fluoropolymer particles reinforced with carbon fibres to increase strength and maintain high electrical conductivity. The polymer formulation and moulding process represented a significant step in reducing plate cost. However, compression moulding is a slow, capital-intensive moulding process not typically well-suited to high volume manufacturing. Higher speed, lower cost moulding processes offer greater promise to further reduce cost. However, the polymer composite materials need to be developed so that they are compatible with both the fuel cell operating requirements and the high speed moulding process.

In principle, such compositions can be moulded directly into complex, intricate shaped components using low cost, high speed moulding processes. Further, these more ductile materials should enable the development of new stack designs because multiple plastics offer greater flexibility to form fuel cell components. The following are typical of compositions that have been proposed having a volume resistivity of 10⁻³ to 10⁻² ohm-cm.

U.S. Pat. No. 4,098,967 to Biddick et al. provides a bipolar plate formed of thermoplastic resin filled with 40-80% by volume finely divided vitreous carbon. Plastics employed in the compositions include polyvinylidene fluoride and polyphenylene oxide. The plates are formed by compression moulding dry blended compositions and possess specific resistance on the order of 0.002 ohm-cm. Compression moulded bipolar plates from solution blends of graphite powder and polyvinylidene fluoride are disclosed in U.S. Pat. No. 3,801,374 to Dews et al. The plate so formed has a density of 2.0 g/cm³ and volume resistivity of 4×10⁻³ ohm-cm.

U.S. Pat. No. 4,214,969 to Lawrence discloses a bipolar plate fabricated by pressure moulding a dry mixture of carbon or graphite particles and a fluoropolymer resin. The carbon or graphite particles are present in a weight ratio to the polymer of between 1.5:1 and 16:1. The polymer concentration is in the range of 6-28% by weight and the volume resistivity of the plate is in the range of 2.5-8.9×10⁻³ ohm-cm.

U.S. Pat. No. 4,554,063-85 to Braun et al. discloses a process for fabricating cathode current collectors. The current collector consists of graphite (synthetic) powder of high purity having particle sizes in the range from 10 micron to 200 micron and carbon fibers which are irregularly distributed therein and have lengths from 1 mm to 30 mm, the graphite powder/carbon fiber mass ratio being in the range from 10:1 to 30:1. The polymer resin used is polyvinylidene fluoride. For producing the current collector, the resin is dissolved in, for example, dimethylformamide. Graphite powder and carbon fibers are then added and the resulting lubricating grease-like mass is brought to the desired thickness by spreading on a glass plate and is dried for about 1 hour at about 50° C. The plates were also formed by casting, spreading, or extrusion.

U.S. Pat. No. 5,582,622 to Lafollette discloses bipolar plates comprising a composite of long carbon fibers, a filler of carbon particles and a fluoroelastomer.

Reference may also be made to PCT publication WO 00/44005 which discloses a shaped article having particular use as a conductive plate in a fuel cell having a volume resistivity of less than 10⁻² ohm-cm and being made from a composition comprising about 5 to about 50% by weight of nickel-coated graphite fibers of a length less than 2 cm, and about 0.1 to about 20% by weight of the graphite, of a non-liquid-crystalline thermoplastic binder resin.

There are a number of other patents that describe methods for manufacturing current collectors of particular formulations or the formulations themselves. Among these are U.S. Pat. No. 4,839,114 to Delphin et al. which includes 35-45% of carbon black fill, and optionally not more than 10% by weight carbon fibers as part of the fill. U.S. Pat. No. 5,942,347 to Koncar et al. describes a bipolar separator plate comprising at least one electronically conductive material in an amount of from about 50% to about 95% by weight of the separator plate, at least one resin in an amount at least about 5% by weight of the separator plate and the hydrophilic agent. The conductive material can be selected from carbonaceous materials including graphite, carbon black, carbon fibers and mixtures thereof. There is no mention of graphite fibers in this patent. Further the preferred amount of carbon fibers comprises 10% by weight.

In U.S. Pat. No. 6,180,275 to Braun et al. and in International Publications Nos. WO 00/30202 and WO 00/30203, there are described moulding compositions for providing current collector plates which include conductive fillers in various forms, including powder and fiber. High purity graphite powder is preferred having a carbon content of greater than 98%. The graphite powder preferably has an average particle size of approximately 23 to 26 microns and a BET-measured surface area of approximately 7-10 m²/g. The description indicates that conventional conductive composites, such as those used to fabricate fuel cell collector plates, typically contain conductive particles having a very high surface area combined with a small particle size. The description further specifies that conventional conductive composites also contain large fibers having a low surface area. The description indicates that fibers having a surface area of less than 10 m²/g coupled with a fiber length in excess of 250 microns are typical. Carbon fibers are specifically mentioned in the description. The preferred composition contains 45-95 weight percent graphite powder, 5-50 weight percent polymer resin and 0-20 weight percent metallic fiber, carbon fiber and/or carbon nanofiber.

U.S. Pat. No. 6,248,467 to Wilson et al., claims a bipolar plate moulded from a thermal setting vinyl ester resin matrix having a conductive powder embedded therein. The powder may be graphite having particle sizes predominantly in the range of 80-325 mesh. Reinforcement fibers selected from graphite/carbon, glass, cotton and polymer fibers are also described. The patent indicates that the presence of graphite fibers does not produce improved conductivity, although it does contribute to flexural strength.

In European Published Patent Application 0,593,408 there is described a composition for forming an electrolytic plate which includes as a filler graphite particles. Organic or inorganic fibers may be used. The patent indicates that when the amount of filler is in the range of 100-2000 parts by weight, the resulting separator can have lower electrical resistance and better mechanical strength.

An example of a typical method for manufacturing shaped bodies formed from plastics-filler mixtures having a high filler content can be found in U.S. Pat. No. 5,804,116 granted to Schmid et al Sep. 8, 1998. In this method which extrusion moulds a plastic-filler mixture containing more than 50% by volume of fillers, the first step involves uniformly distributing the filler in a molten plastic, then discharging the mixture and allowing it to harden. The hardened mixture is then broken up and ground and the ground mixture or fractions thereof are made uniform as to grain size and then extruded by means of an extruder with a conveying input zone to form moulded bodies.

The problem in realising the advantages of moulded thermoplastic polymer parts has been related to the inverse relationship between concentration of conductive filler on the one hand and processability and mechanical properties on the other.

It is desirable to achieve a combination of properties and processability for a mouldable polymer composite formulation for use in a high speed moulding process without limitations on practical utility. Thus, it would be desirable to optimise the composition to ensure that the desired goals are achieved.

There remains a need to develop methods that allow the processing of compositions to ensure the production of plates having the best level of properties desired for the electrically conductive plates and which meet all of the chemical, physical and electrical requirements as well as the cost requirements. This invention is based on a better understanding of the interactions between materials, manufacturing processes, and performance-in-use characteristics, which understanding allows the creation of a superior cost-in-use plate.

The disclosures of all patents/applications referenced herein may be referred to where appropriate.

### SUMMARY OF THE INVENTION

In accordance with one aspect of the present invention, there is provided an improved process for manufacturing an electrically conductive shaped article, which improvement involves carrying out all of the process steps under relatively low shear strain conditions. This is particularly important when the article is a conductive flow field separator or bipolar plate made from a composition that includes conductive graphite fibre as part of the conductive filler. Reduced shear strain results in decreased manipulation and deformation of graphite fiber and powders, thus ensuring that the conductivity and strength of the separator plate is maximized. The shear strain here mentioned is equal to shear rate multiplied by shear time as defined in the reference book “Rheometers for molten plastics” by John M. Dealy.

Therefore, one preferred embodiment of the present invention provides a process for fabricating an electrically conductive shaped article, wherein the article comprises a composition comprising:
(a) from about 10 to about 50% by weight, preferably from about 15 to about 30%, most preferably from. about 20 to about 25%, of a plastic;
(b) from about 10 to about 70%o by weight, preferably from about 15 to about 40%, most preferably from about 20 to about 30%, of a graphite fibre filler having fibres with a length of from about 15 to about 500, preferably from about 50 to about 300, most preferably from about 100 to about 250, μm; and
(c) from 0 to about 80% by weight, preferably from about 10 to about 60%, most preferably from about 40 to about 60%, of a graphite powder filler having a particle size of from about 20 to about 1500, preferably from about 50 to about 1000, most preferably from about 100 to about 500 μm;

the process comprising the following process stages:
i) preparing one or more feeds of the plastic and fillers;
ii) feeding the plastic and fillers to a melt compounding stage wherein a homogeneous melt of the composition is obtained;
iii) transferring the homogeneous melt; and
iv) subjecting the homogeneous melt to a moulding process to produce the conductive shaped article; and

wherein all of the process stages are conducted under low shear strain of less than 80000, preferably less than 60000, more preferably less than 30000 and most preferably less than 10000 so that the shaped article has a through-plane resistivity of less than about 600 μOhm-m.

A second embodiment of the present invention provides process for fabricating an electrically conductive shaped article, comprising the steps of:
(a) providing about 10 to about 50% by weight, preferably from about 15 to about 30%, most preferably from about 20 to about 25%, of a plastic; from about 10 to about 70% by weight, preferably from about 15 to about 40%, most preferably from about 20 to about 30%, of a graphite fibre filler having fibres with a length of from about 15 to about 500, preferably from about 50 to about 300, most preferably from about 100 to about 250, μm; and from 0 to about 80% by weight, preferably from about 10 to about 60%, most preferably from about 40 to about 60%, of a graphite powder filler having a particle size of from about 20 to about 1500, preferably from about 50 to about 1000, most preferably from about 100 to about 500, μm;
(b) separately feeding the plastic, graphite fibre and graphite powder into a low shear, mixing and extrusion device wherein the plastic is melted and the fibre and graphite fillers are each mixed with the molten plastic and then extruded into an extrudate; and
(c) subjecting the extrudate to a moulding process to produce the electrically conductive shaped article; and

wherein all the steps are conducted at low shear strain of less than 80000, preferably less than 60000, more preferably less than 30000 and most preferably less than 10000 so that the article has a through-plane resistivity of less than about 600 μOhm-m.

In a further embodiment of the present invention, a conductive flow field separator plate is provided by using the compositions and the low shear strain process described in the first and the second embodiment of the present invention, wherein die plate has a flexural strength of greater than about 3000 psi (21 MPa), preferably greater than about 4000 psi (28 MPa), most preferably greater than about 6000 psi (42 MPa), and a through-plane resistivity of not more than about 600 μOhm-m.

Reference is now made to the following specific embodiments for the purpose of illustrating the invention.

### BRIEF DESCRIPTION OF THE DRAWINGS

The preferred embodiments of the present invention will be described with reference to the accompanying drawings in which like numerals refer to the same parts in the several views and in which:

FIG. 1 is a plot of bulk resistivity of plates made in accordance with the preferred embodiments of the present invention vs. filler weight percentage;

FIG. 2 is a plot of contact resistivity of plates made in accordance with the preferred embodiments of the present invention vs. the filler weight percentage;

FIG. 3 is a plot of plate flexural strength of plates made in accordance with the preferred embodiments of the present invention vs. filler weight percentage;

FIG. 4 is a plot of plate surface roughness of plates made in accordance with the preferred embodiments of the present invention vs. filler weight percentage;

FIG. 5 is a schematic representation of an ETP line with the steps of plastication and then billet cutting and transferring to a moulding press which may be used to carry out a fabrication process of the invention;

FIG. 6 is a schematic representation of an in-line compounding-moulding process with a twin screw extruder and a compression moulding press which may be used to carry out another fabrication process of the invention; and

FIG. 7 is a schematic representation of another in-line compounding-moulding process with a reciprocating co-kneading compounding extruder and a compression moulding press that may be used to carry out another fabrication process of the invention.

FIG. 8 is a plot of through-plane resistivity of plates made in accordance with the preferred embodiments of the present invention vs. shear sprain.

### DETAILED DESCRIPTION OF THE PREFERRED EMBODIMENTS

The preferred embodiments of the present invention will now be described with reference to the accompanying figures.

In accordance with a preferred aspect of the present invention, there is provided an improved process for fabricating an electrically conductive shaped article. The article is made from a composition comprising:
(a) from about 10 to about 50% by weight, preferably from about 15 to about 30%, most preferably from about 20 to about 25%, of a plastic;
(b) from about 10 to about 70% by weight, preferably from about 15 to about 40%, most preferably from about 20 to about 30%, of a graphite fibre filler having fibres with a length of from about 15 to about 500, preferably from about 50 to about 300, most preferably from about 100 to about 250, μm; and
(c) from 0 to about 80% by weight, preferably from about 10 to about 60%, most preferably from about 40 to about 60%, of a graphite powder filler having a particle size of from about 20 to about 1500, preferably from about 50 to about 1000, most preferably from about 100 to about 500 μm.

The process may include process stages of: preparing one or more feeds of the plastic and fillers; feeding the plastic and fillers to a melt compounding stage wherein a homogeneous melt of the composition is obtained; transferring the homogeneous melt; and subjecting the homogeneous melt to a moulding process to produce the conductive shaped article. All the process stages are conducted under low shear strain of less than 80000, preferably less than 60000, more preferably less than 30000 and most preferably less than 10000 so that the through-plane resistivity of the article is less than about 600 μOhm-m.

As used in this specification, shear strain refers to the shear deformation of a material and equals the shear rate multiplied by the shear time. Shear strain has no units.

In a preferred form of the process of the invention, all stages form part of the process and most preferably each stage is conducted at low shear strain conditions. Preferably the total shear strain is less than about 80000, more preferably less than about 60000, and most preferably less than 30000 and most preferably less than 10000. The following sets out guidelines and suggestions for how these low shear strain conditions can be best achieved in the present invention. The application of low shear strain conditions to the present process at each stage of the process has been found to be critical to producing the articles, preferably places of the present invention. In preferred forms of the invention, one may employ low shear strain conditions at 1, 2, 3 or 4 stages of the manufacturing process. In particular, it is preferred that the melt compounding and moulding stages be conducted at low shear strain conditions, as these stages can involve the greatest manipulation of the mixture.

Generally, a preferred low shear strain process for fabricating the articles, preferably plates, of the present invention include 4 major stages:
1. preparation of formulations at low shear strain;
2. melt compounding of the formulations at low shear strain;
3. melt dosing and transferring at low shear stain; and
4. moulding the plates at low shear strain.
   1. Preparation of Formulations at Low Shear Strain:

It has been found that the first stage of the process may be achieved in one of two ways. Thus formulations may be prepared at low shear strain conditions as follows

1). Dry Blending:

The resin and fillers are dry blended into a homogeneous mixture through a blender or a tumbling drum at room temperature. The preferred form of the resin is ground powder with a particle size of less than 1 mm to assure a homogeneous distribution in the mixture. During the blending process, low shear mixing is assured by a low mixing speed and a mixing temperature below the resin's melting point. Mixing is carried out for as small a time as possible to minimize shear strain. High mixing speeds can damage filler integrity while high mixing temperatures can cause melting of the resin and subsequently increase of the shear deformation of the mixture. An example of a suitable commercial mixer is a Henschel blender.

2). Feeding Resin and Fillers Directly into a Melt Compounding Device:

The resin and fillers can be directly and/or separately fed into a melt compounding device without the above described dry blending step. In this way, the resin and fillers may be metered accurately via one or more loss-in-weight feeder(s) according to the desired weight percentage of each component in the formulation. The resin and fillers may also be directly added as a homogeneous mixture to the compounding device. It is preferable that the additions take place downstream of the resin addition so that the fillers are added to a melt of the resin. The feeding screw in the feeder should be selected to provide low shear strain to the fillers. An example of a suitable feeder is a Loss-in-weight K-tron feeder.

2. Melt Compounding of the Formulations at Low Shear Strain:

It has been found that the properties of the resulting articles or plates are directly related to melt quality of the resin/fillers mixtures. In order to achieve high conductivity of the articles or plates, the filler integrity must be retained via homogeneous compounding at low shear strain conditions. The low shear compounding device can be a batch mixer, a single or twin screw extruder with deep screw flights and gentle mixing elements or a reciprocating single screw co-kneader with gentle mixing elements. The shear action that occurs in the compounding process must be minimized while a homogeneous distribution of the fillers in the melt must be assured. The compounding time should also be minimized. The shear strain imparted to the fillers can be minimised by choosing deep screw flight, a low compression ratio, less intensive mixing elements, a large die size and a short mixing time. During the compounding operation, a low screw rotation speed and low screw back pressure are also important to ensure low shear strain to the fillers. According to the current invention, the preferred screw flight depth is not smaller than 0.5 mm and more preferably not smaller than 1 mm. The compression ratio of the screw ranges from 6:1 to 1:1 and preferably from 2:1 to 1:1. The screw backpressure ranges from 0 to 1000 PSI (7 MPa) and preferably from 0 to 100 PSI (0.7 MPa). The screw rpm ranges from 1 to 500 rpm and preferably from 20 to 200 rpm. The die size or diameter of the compounding device ranges from 5 mm to 1000 mm and preferably from 20 mm to 200 mm. These conditions represent preferred apparatus configuration to achieve low shear strain compounding.

3. Melt Dosing and Transferring at Low Shear Strain:

In order to make an article or plate with consistent part dimensions and tolerances, the melt from the compounding stage mentioned above should be metered by a melt dosing device and then transferred to a mould for making the article or plate. The application of minimum shear for as small a time as possible during this melt dosing and transferring stage is also important because high shear strain can damage the integrity of the fillers and cause deterioration of the plate conductivity. Also high shear strain can cause filler orientation that affects significantly the homogeneity of plate mechanical properties. High shear can be created if:
1. the melt dosing and transferring device has narrow melt passages such as melt flow channels, melt flow pipes, slot dies or openings, or
2. the melt is forced to pass the dosing and transferring device at a high speed.

According to the present invention, the cross sectional size of the melt dosing and transferring passage ranges from 2 mm to 1000 mm and preferably from 20 mm to 500 mm. These limitations are preferred for achieving low shear strain conditions in the process of the invention. Most preferably the melt from the compounding stage is collected directly by the mould cavity so that the melt dosing and transferring stage am eliminated and the shear is minimised.

4. Moulding Plates at Low Shear Strain:

In the plate moulding stage, the melt is deposited in the mould and forced to flow to fill the mould at high temperature and high compression pressure. During the melt flow course, the mould walls shear the fillers. The longer the melt flow path is, the higher is the shear. The higher the melt flow speed or the compression pressure is, the higher is the shear. At a certain melt temperature the melt viscosity is constant. Therefore, in order to have minimum shear and shorten the melt flow path, a homogeneous melt distribution over the mould cavity area must be maximised before a compression pressure is applied on the mould. According to the preferred embodiment of the current invention, the melt flow path ranges from 0 to 250 mm and preferably from 0 to 100 mm. The melt flow speed ranges from 0 to 250 mm/s and preferably from 0 to 100 mms. Again these apparatus configurations ensure that this stage is conducted under low shear strain conditions.

The plasticator, which may be used in the compounding stage, is typical of those used in the art, an example of which is the known term extrusion-transfer-pressing (ETP) process. Temperatures and times for processing are selected based on the materials to be processed. Depending on the melting point of the polymer selected, the processing temperature ranges from 150° C. to 400° C., and preferably from 250° C. to 380° C.

The invention also encompasses an improved process for fabricating an electrically conductive shaped article, comprising the steps of:
a) providing about 10 to about 50% by weight, preferably from about 15 to about 30%, most preferably from about 20 to about 25%, of a plastic; from about 10 to about 70% by weight, preferably from about 15 to about 40%, most preferably from about 20 to about 30%, of a graphite fibre filler having fibres with a length of from about 15 to about 500, preferably from about 50 to about 300, most preferably from about 100 to about 250, μm; and from 0 to about 80% by weight, preferably from about 10 to about 60%, most preferably from about 40 to about 60%, of a graphite powder filler having a particle size of from about 20 to about 1500, preferably from about 50 to about 1000, most preferably from about 100 to about 500, μm;
b) separately feeding the plastic, graphite fibre and graphite powder into a low shear, mixing and extrusion device wherein the plastic is melted and the fibre and graphite fillers are each mixed with the molten plastic and then extruded into an extrudate; and
c) subjecting the extrudate to a moulding process to produce the electrically conductive shaped article; and

wherein all the steps are conducted at low shear strain of less than 80000, preferably less than 60000, more preferably less than 30000 and most preferably less than 10000 so that the article has a through-plane resistivity of less than about 600 μOhm-m.

A typical continuous low shear mixing and extrusion device may be a twin-screw extruder with a low shear strain screw design or a reciprocating co-kneading compounding extruder. A typical example of the former device is a ZSK twin screw extruder from Werner & Pfleider. A typical example of the latter device is a BUSS® Kneader.

In a preferred form of the process of the invention, the electrically conductive shaped article is a conductive flow field plate, also known as a separator plate or a current collector plate or a bipolar plate. The plate has improved flexural strength, reduced bulk resistivity and in a more preferred form, has reduced surface roughness.

The conductive flow field separator plate is preferably formed by a low shear strain extrusion moulding process. The plate is formed from a composition comprising:
(a) from about 10 to about 50% by weight, preferably from about 15 to about 30%, most preferably from about 20 to about 25%, of a plastic;
(b) from about 10 to about 70% by weight, preferably from about 15 to about 40%, most preferably from about 20 to about 30%, of a graphite fibre filler having fibres with a length of from about 15 to about 500, preferably from about 50 to about 300, most preferably from about 100 to about 250, μm; and
(c) from 0 to about 80% by weight, preferably from about 10 to about 60%, most preferably from about 40 to about 60%, of a graphite powder filler having a particle size of from about 20 to about 1500, preferably from about 50 to about 1000, most preferably from about 100 to about 500, μm.

The plate has a flexural strength of greater than about 3000 psi (21 MPa), preferably greater than about 4000 psi (28 MPa), most preferably greater than about 6000 psi (42 MPa), and a through-plane resistivity of not more than about 600 μOhm-m. More preferably the plate has a surface roughness of not more than 100 micro inch (0.00254 mm).

The plastic used in the process may be selected from all thermoplastic and thermosetting plastics as well as elastomers which are suitable for working according to the method of the invention, as long as they have a sufficient temperature resistance to permit their being processed in the required manner. The selection will of course be dependant on the intended purpose of the article being manufactured. Suitable plastics that are preferably thermoplastically processable fluorine-containing polymers are employed. Examples are copolymers of tetrafluoroethylene with perfluoropropylene (FEP), copolymers of tetrafluoroethylene with perfluoroalkylvinylethers (PFA), copolymers of ethylene and tetrafluoroethylene (ETFE), polyvinylidene fluoride (PVDF), polychlorotifluoroethylene, etc., polyolefines like polyethylene or polypropylene, cycloolefine copolymers like norbylideneethylene copolymers and other copolymers of this type manufactured with metallocene catalysts, polyamides, thermoplastically workable polyurethanes, silicones, novolaks, polyaryl sulfides like polyphenylenesulfide (PPS), polyaryletherketones which have a permanent temperature resistance according to DIN 51 005 of at least 80° C. Plastics having a polyvinylidene and cycloolefin basis are preferably used. Also, mixtures of plastics combinable with one another can be used if this is advantageous for example for improving processability or optimising of the product properties.

Aromatic thermoplastic liquid crystalline polymers suitable for the practice of the present invention include those described in U.S. Pat. Nos. 3,991,013; 3,991,014; 4,011,199; 4,048,148; 4,075,262; 4,083,829; 4,118,372; 4,122,070; 4,130,545; 4,153,779; 4,159,365; 4,161,470; 4,169,933; 4,184,996; 4,189,549; 4,219,461; 4,232,143; 4,232,144; 4,245,082; 4,256,624; 4,269,964, 4,272,625; 4,370,466; 4,383,105; 4,447,592; 4,522,974; 4,617,369; 4,664,972; 4,684,712; 4,727,129; 4,727,131; 4,728,714; 4,749,769; 4,762,907; 4,778,927; 4,816,555; 4,849,499; 4,851,496; 4,851,497; 4,857,626; 4,864,013; 4,868,278; 4,882,410; 4,923,947; 4,999,416; 5,015,721; 5,015,722; 5,0254,082; 5,086,158; 5,102,935; 5,110,896; 5,143,956, the disclosures of which may be referred to where appropriate.

Useful aromatic thermoplastic liquid crystalline polymers include polyesters, poly(ester-amides), poly(ester-imides), and polyazomethines. Especially useful are aromatic thermoplastic liquid crystalline polymers that are polyesters or poly(ester-amides). It is also preferred in these polyesters and poly(ester-amides) that at least about 50%, more preferably about 75% of the bonds to ester or amide groups, i.e., the free bonds of —C(O)O— and —C(O)NR¹— where R¹ is hydrogen or hydrocarbyl.

In a preferred embodiment of the present invention, the polyesters or poly(ester-amides) are made from monomers such as one or more aromatic dicarboxylic acid such as isophthalic acid, terephthalic acid, 4,4-bibenzoic acid, 2,6-naphthalene dicarboxylic acid, one or more aromatic dihydoxy compounds such as hydroquinone, a substituted hydroquinone such as methylhydroquinone, t-butylhydroquinone, and chlorohydroquinone, resorcinol, 4,4′-biphenol, 2,6-naphthalenediol, and 2,7-naphthalenediol, one or more aromatic hydroxyacids such as 3-hydroxybenzoic acid, 4-hydroxybenzoic acid, and 6-hydroxy-2-naphthoic acid and (in the case of poly(ester-amides)) one or more aromatic diamines such as p-phenylenediamine or m-phenylenediamine.

Included within the definition herein of an aromatic thermoplastic liquid crystalline polymer is a blend of 2 or more aromatic thermoplastic liquid crystalline polymers, or a blend of an aromatic thermoplastic liquid crystalline polymer with one or more non-aromatic thermoplastic liquid crystalline polymers wherein the aromatic thermoplastic liquid crystalline polymer is the continuous phase.

In a preferred form of the invention, the composite for the plate includes graphite fibre having a length of from about 15 to about 500, preferably from about 50 to about 300, most preferably from about 100 to about 250 μm. Typically the average diameter of the fiber is in the range of 8 to 15 μm. The graphite fibre is preferably present in an amount in the range of from about 10 to about 70% by weight, preferably from about 15 to about 40%, most preferably from about 20 to about 30%, by weight of the total composition. The graphite powder is preferably present in an amount in the range of from about 0 to about 80% by weight, preferably from about 10 to about 60%, most preferably from about 40 to about 60% by weight of the total composition and have a particle size in the range of from about 20 to about 1500, preferably from about 50 to about 1000, most preferably from about 100 to about 500 μm.

The graphite fibre can be selected from any of the commercially available free flowing fibres. The graphite fiber can be pitch based or PAN-based. In the fiber production process, the fiber is graphitised at very high temperature for high graphite purity. The graphite powder may be selected from synthetic or natural graphite powders in the form of flakes or sphericals and is preferably in the form of flakes.

This plate is for use in a fuel cell which may be selected from direct methanol, direct hydrogen and reformate hydrogen PEM fuel cells.

Previously, formulations for such plates have focused on the particulate or powder graphite as the major requirement for conductivity. Typically, maximising the conductive material was considered to provide the best plates. While it was recognised that the use of powder did not necessarily produce plates of suitable strength, any perceived strength problems have been addressed by including fibre as part of the conductive filler.

The present invention now recognises that in order to produce plates that can provide benefits in an overall fuel cell design, the right balance of properties must be achieved. The polymer composite described above ensures that the right amount of graphite fibre is selected so that reasonable conductivity is achieved in a plate of the desired flexural strength so that plates of suitable thickness can be produced. The graphite powder is used since it is less costly than the fibres and the powder contributes to providing the required conductivity. Viable plates of less cost can be obtained from the composite. Thinner plates are key to controlling the overall size of the fuel cell system and to reducing the overall resistance of the fuel cell.

An unexpected advantage of the preferred plates exists wherein the amount of the fibre is in the range of from about 10 to about 70% by weight, preferably from about 15 to about 40%, most preferably from about 20 to about 30% of the total filler loading. This is the ability to control the surface roughness of the plate. It was found that the surface roughness of the plate is a non-monotonous function of the graphite fiber loading in the formulation. When flow fields are added, plates offer increased performance because of the improved surface smoothness.

This is invention also recognizes that very homogeneous mixing of the polymer with the graphite fiber and powder filler is required to achieve optimum electrical and mechanical properties. The use of conventional high shear mixing devices can adversely affect these desired properties by causing breakage and geometrical changes to the fiber and filler particles. In the fabrication processes of the in-line compounding-moulding type in which process the compositions from this invention mentioned earlier are compounded via a twin screw extruder or a reciprocating single screw co-kneading extruder commonly called a BUSS® Kneader equipped with low shear strain, low compression ratio mixing elements. The polymer resin and graphite fillers are fed either together or separately into the extruder. Preferably the polymer resin is fed into the first zone of the extruder and the fillers being fed into later zones where the polymer is in molten state. In the extruder or kneading device, the polymer and fillers are compounded into a homogeneous molten mixture, the molten mixture being collected and metered for a certain shot size, the metered melt being transferred to a heated mould and then pressed in the mould to form a plate product.

The present invention provides a formulation for manufacturing conductive plates having optimum plate properties. The prior art has not clearly recognised that graphite powder alone as the conductive filler provides inferior conductivity as compared with combinations of powder and fiber. Since graphite fiber is so costly, ensuring that maximum conductivity is achieved with minimum fiber is highly desirable. Plate strength is also a benefit from the use of the graphite fiber and therefore, balancing the proportion of graphite fiber in the total filler is important. The combinations proposed by the present invention are unexpectedly superior with respect to producing conductive plates that exhibit substantially increased plate flex strength and improved bulk resistivity. Thus, the composition provides the ideal balance for optimising the required properties for conductive plates. In addition, the plates have reduced surface roughness, which is critical for the formation of flow fields and for the operation of the fuel cell in which they are employed.

The selection of binder materials used in compositions for the present invention is relatively straightforward. The determinative factor is that the Glass Transition Temperature Tg of the thermoplastic resin is preferably at least 80° C. As the temperature of a polymeric material is lowered below the glass transition temperature, it undergoes a marked chance in properties associated with the virtual cessation of local molecular motion. These properties include hardness, brittleness, stiffness, and environmental resistance. For crystalline polymers, the molecular motion is essentially absent below this transition temperature and the material behaves as a hard, glassy solid. It is in this state that it is most resistant to creep, weathering and other chemicals. In order to guarantee the best selection of properties to last over time at the application temperature, the polymeric binder should have a glass transition temperature higher than the application temperature, which is normally above 80° C. in most of PEM fuel cells.

To maximise electrical conductivity, it is necessary to maximise the electrically conductive filler loading levels. An increase of electrically conductive filler loading produces a corresponding increase in melt viscosity of the composite. Thus, regardless of the polymeric binder material selected, the filler loading must be limited to ensure some minimum degree of melt flow during processing.

Preferred resins are polyester-based liquid crystalline polymers (LCPs), which exhibit excellent chemical resistance, thermal stability and gas barrier properties.

In a preferred embodiment of the present invention, the shaped article, namely the plate, is a bipolar plate having fluid flow channels moulded into the surface thereof and is suitable in use in hydrogen or direct methanol fuel cells with little or no post-moulding finishing required.

Aromatic thermoplastic liquid crystalline polymers are manufactured and commercially available as pellets, typically in diameters of about 0.125 inch (3.175 mm). Through cryogenic grinding process, they can be ground into finer granulates or powders. In this invention, both pellet form and powder form resins are used.

Typically, a plastic powder is dry mixed as by tumbling, with the graphite filler to form a coarse homogeneous mixture. This mixture is fed to the feed throat of a compounding device with a low shear strain screw or low shear strain mixing elements. Examples of these devices are single screw plasticators with deep screw flights, reciprocating BUSS® kneaders and ZSK twin screw extruders. The action of the screw or mixing element causes the filler to disperse within the LCP resin melt. The molten dispersion is extruded and fed to a mould in which the melt hardens to form a shaped article that is then ejected from the mould.

It is an important aspect of the present invention that the ingredients be subject to as little shear strain as possible because shearing force and the extent to which it is applied during melt mixing and extrusion results in breakage of the fillers and therefore causes degradation of their conductivity performance. Thus all steps in the process of the present invention should be performed with an eye toward keeping shear strain low with a prerequisite condition that a homogeneous filler distribution in the melt must be assured.

For the purposes of the present invention, premixing the dry or unmelted ingredients at low shear strain includes simply feeding the separate ingredients directly to the feed hopper of the extruder or compounding machine such as by employing controlled rate-of-weight-loss feeders where the mixture is made in situ within the feed throat of the machine.

This invention enables the production of thinner, lighter, and lower costs conductive articles while significantly reducing or eliminating the need for the costly machining steps employed at the current state of the art. In the preferred embodiment, current collectors having complex gas flow networks, highly suitable for use in fuel cells may be directly moulded, requiring little or no finishing prior to use.

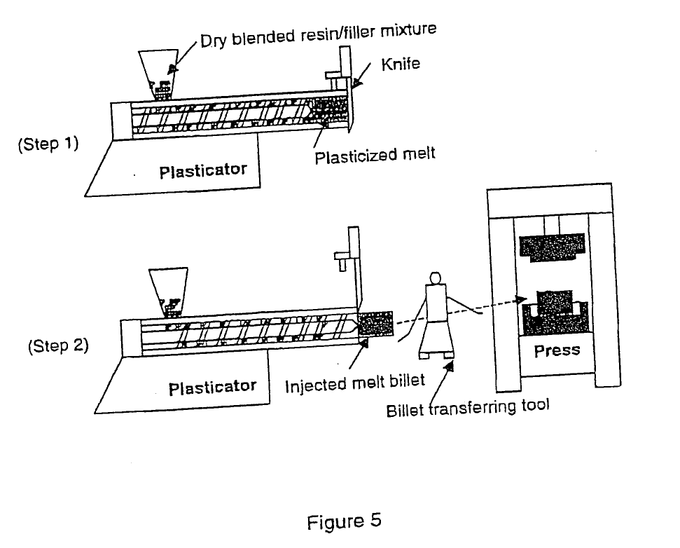

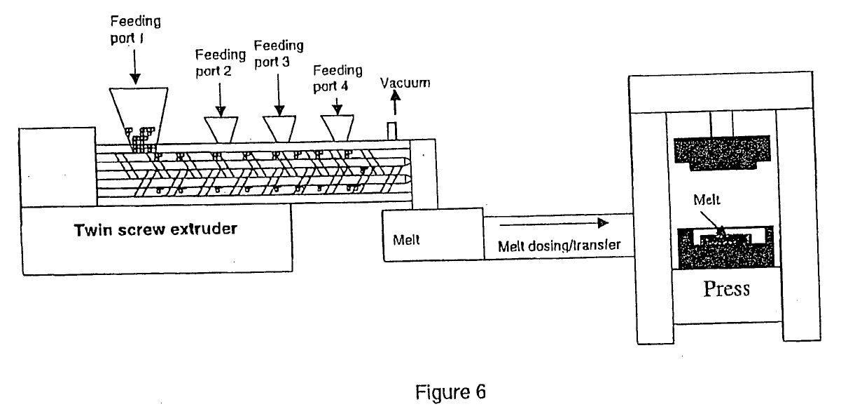

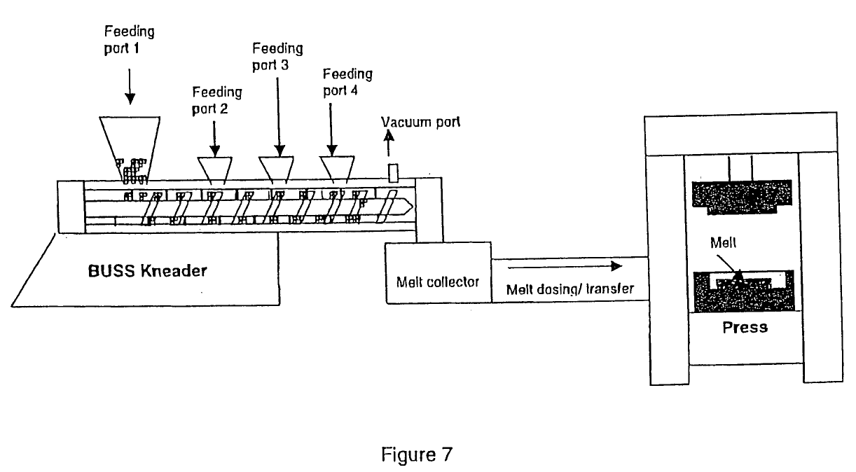

While the methods and appropriate apparatus arrangements are as seen in FIGS. 5, 6 and 7, the most preferred is the method using the BUSS® Kneader because it provides most flexibility to control mixing and shear strain which is believed to be an important feature of the fabrication methods of the present invention.

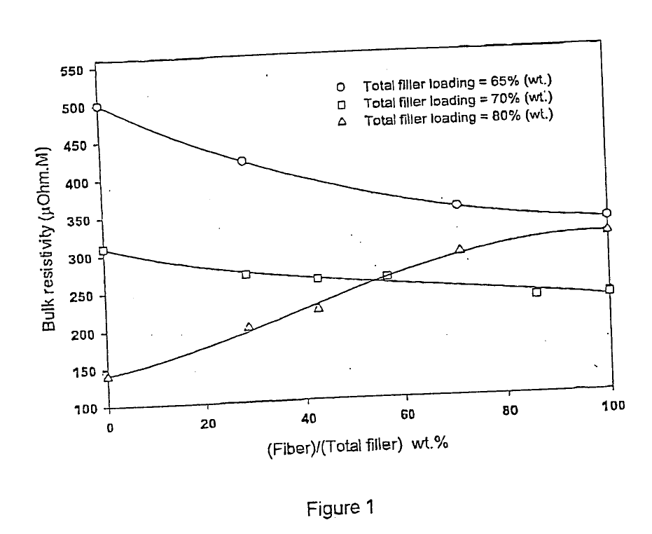

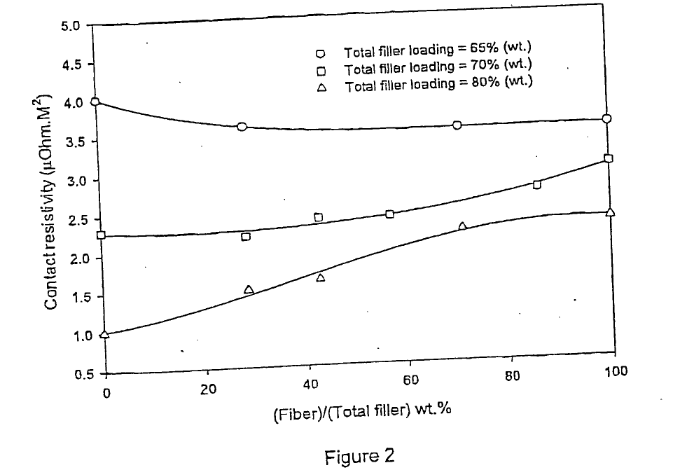

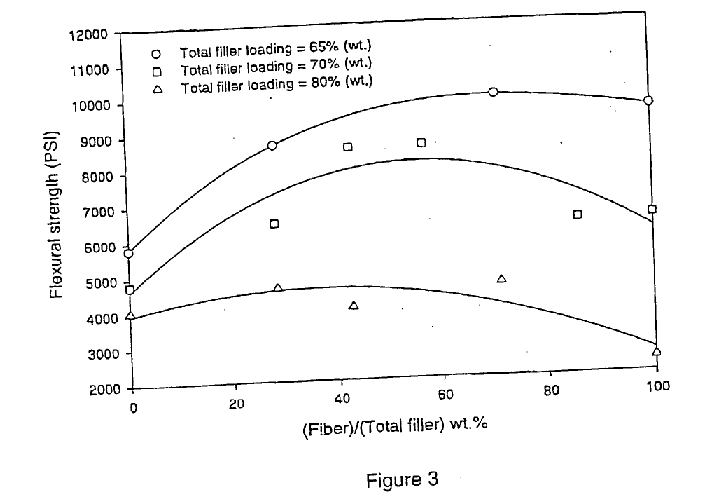

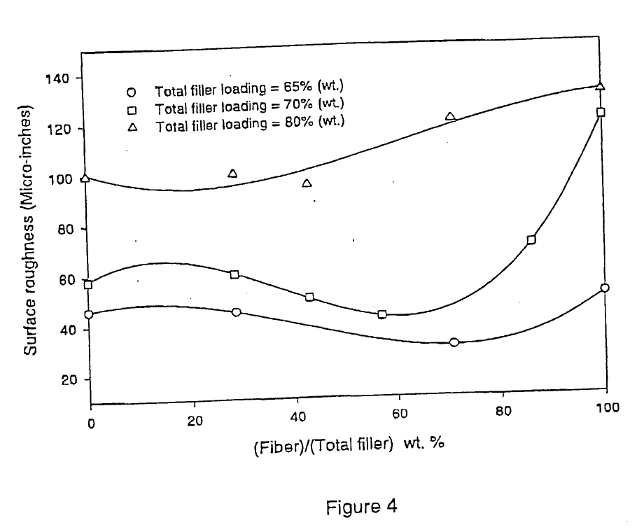

The graphs of FIGS. 1 to 4 clearly demonstrate that plate resistivity decreases with increasing filler loading, which is not totally unexpected. However, the results also demonstrate that graphite powder alone as the filler provides inferior conductivity as compared with combinations of powder and fiber. Since graphite fiber is so costly, ensuring that maximum conductivity is achieved with minimum fiber is highly desirable. Plate strength is also a benefit from the graphite fiber and therefore, balancing the proportion of graphite fiber in the total filler is important. The combinations proposed by the present invention are unexpectedly superior with respect to producing conductive plates that exhibit increased plate flex strength and improved bulk resistivity. Thus, the composition provides the ideal balance for optimising the required properties for conductive plates.

The testing methods and standards used to obtain the results in the Table 1 comprise the following:
Bulk resistivity: FOUR POINT PROBE
Contact resistivity and through-plane resistivity: Samples cut to 4″×4″ (10.16 cm×10.16 cm) were sandwiched between two gold-plated stainless steel plates and measured for voltage-drop at constant current and calculated for contact resistivity and through-plane resistivity according to Ohm Law
Flexural strength: ASTM D790
Surface roughness: GOULD SURF-INDICATOR

The invention may be varied in any number of ways as would be apparent to a person skilled in the art and all obvious equivalents and the like are meant to fall within the scope of this description and claims. The description is meant to serve as a guide to interpret the claims and not to limit them unnecessarily.

The following examples illustrate the various advantages of the preferred method of the present invention.

### EXAMPLES

Resin

A polyester-based liquid crystalline polymer (LCP) Zenite® 8000, produced by DuPont, ground into powder form with an average size of 391 μm: Tg=120-140° C.; and Melting point Tm=260-280° C. This resin was used for moulding all conductive plates referred described hereinafter.

Conductive Fillers

Synthetic Graphite Powder:
Particle size distribution range: from 20 μm to 1500 μm; Average size=240 1μm
BET (Multi-point or Single-point, Brunauer, Emmett and Teller method) Surface Area: 2-3 m²/g
Bulk density: 0.5-0.7 g/cm3
Real density: 2-2.21 g/cm3
Pitch-based graphite fiber with no surface sizing or treatment

Fiber length distribution range: from 15 to 500 μm; Average size=106 μm

| | |
|---|---|
| Fiber diameter | 8-10 μm |
| Bulk density | 0.3-0.5 g/cm3 |
| Real density | 2-2.21 g/cm3 |

### Example 1

For preparation of a conductive material mixture for the conductive plates from this invention, 3 lbs (1.36 kg) of dried liquid crystalline polymer (LCP)-Zenite® 8000 resin powder (average particle size=391 μm) and 7 lbs (3.16 kg) of synthetic graphite powder(average particle size 240 μm were dry blended at room temperature in a rotating drum blender. This dry-blended rein/filler mixture has 70% (by weight) of graphite powder and 30% (by weight) of liquid crystalline polymer resin. The mixture was moulded into conductive plates through a Extrusion-Transfer Pressing process made by CTC Composite Technologies (Dayton, Ohio) under the following conditions:
Plasticator with low shear strain screw: Diameter=αmm, L/D=13:1,
Screw rotating speed 41 rpm
Screw injection shot size: 2.5″ (6.35 cm)
Extruder die form: Billet in 60 mm diameter
Extruder barrel temperature: 450° F. (232° C.) (Zone 1), 640° F. (338° C.) (Zone 2), 640° F. (338° C.) (Zone 3), 640° F. (338° C.) (Die)
Material in-barrel plasticating time: 5 min
Hydraulic press: 200 Ton (181,400 kg)
Mould size: 9″×6″ (22.86 cm×15.24 cm)
Mould temperature: 445° F. (229° C.) on core, 455° F. (235° C.) on cavity
Compression pressure applied: 200 Ton (181,400 kg)
Compression time: 3 min
Cooling under pressure: 3 min cooling under 60 Ton (54,400 kg) pressure
Moulded plate size: 9″×6″×⅕″ (22.86 cm×15.24 cm×0.5 cm)

The material mixture in powder form was fed into the extruder (plasticator) hopper and plasticated by the screw in the heated machine barrel. The screw moved forward to push out a melt billet, which was transferred quickly to the compression mould installed on the hydraulic press. The melt billet was pressed under the pressure and moulded into a flat plate form. The plate was removed at the mould temperature and finally cooled under pressure to the room temperature. The thus moulded plate was tested for bulk resistivity, contact resistivity, plate flexural strength and plate surface roughness. These tests results are listed in the following Table 1.

For all examples, the same experimental procedures as described above were used except different plate material formulations were employed. All plate test formulations and results are listed in he following Table 1.

TABLE 1
Testing Results On Conductive Plates:

| | Plate | Bulk | Contact | Flexural | Surface |
|---|---|---|---|---|---|
| Example | formulation | resistivity | resistivity | strength | roughness |
| No. | (wt %) | (μΩM) | (μΩM²) | (PSI) | (Microinch) |
| 1 | 30% LCP + 70% | 310 | 2.3 | 4789 (33.5 MPa) | 58 (1.47 μm) |
| | graphite | | | | |
| | powder | | | | |
| 2 | 30% LCP + 20% | 270 | 2.2 | 6468 (45.2 MPa) | 60 (1.52 μm) |
| | graphite | | | | |
| | fiber + 50% | | | | |
| | graphite | | | | |
| | powder | | | | |
| 3 | 30% LCP + 30% | 260 | 2.4 | 8536 (59.8 MPa) | 50 (1.27 μm) |
| | graphite | | | | |
| | fiber + 40% | | | | |
| | graphite | | | | |
| | powder | | | | |
| 4 | 30% LCP + 40% | 260 | 2.4 | 8555 (59.9 MPa) | 42 (1.07 μm) |
| | graphite | | | | |
| | fiber + 30% | | | | |
| | graphite | | | | |
| | powder | | | | |
| 5 | 30% LCP + 60% | 230 | 2.7 | 6367 (44.6 MPa) | 70 (1.78 μm) |
| | graphite | | | | |
| | fiber + 10% | | | | |
| | graphite | | | | |
| | powder | | | | |
| 6 | 30% LCP + 70% | 230 | 3.0 | 6427 (44.9 MPa) | 100 (2.54 μm) |
| | graphite | | | | |
| | fiber | | | | |
| 7 | 20% LCP + 80% | 140 | 1.0 | 4055 (28.4 MPa) | 100 (2.54 μm) |
| | graphite | | | | |
| | powder | | | | |
| 8 | 20% LCP + 22.9% | 200 | 1.5 | 4648 (32.5 MPa) | 100 (2.54 μm) |
| | graphite | | | | |
| | fiber + 57.1% | | | | |
| | graphite | | | | |
| | powder | | | | |
| 9 | 20% LCP + 34.3% | 220 | 1.6 | 4045 (28.3 MPa) | 95 (2.41 μm) |
| | graphite | | | | |
| | fiber + 45.7% | | | | |
| | graphite | | | | |
| | powder | | | | |
| 10 | 20% LCP + 57.1% | 290 | 2.2 | 4625 (32.4 MPa) | 120 (3.05 μm) |
| | graphite | | | | |
| | fiber + 22.9% | | | | |
| | graphite | | | | |
| | powder | | | | |
| 11 | 20% LCP + 80% | 310 | 2.3 | 2399 (16.8 MPa) | 130 (3.30 μm) |
| | graphite | | | | |
| | fiber | | | | |
| 12 | 35% LCP + 65% | 500 | 4.0 | 5800 (40.6 MPa) | 46 (1.17 μm) |
| | graphite | | | | |
| | powder | | | | |
| 13 | 35% LCP + 18.6% | 420 | 3.6 | 8669 (60.7 MPa) | 45 (1.14 μm) |
| | graphite | | | | |
| | fiber + 46.4% | | | | |
| | graphite | | | | |
| | powder | | | | |
| 14 | 35% LCP + 46.4% | 350 | 3.5 | 9882 (69.2 MPa) | 30 (0.76 μm) |
| | graphite | | | | |
| | fiber + 18.6% | | | | |
| | graphite | | | | |
| | powder | | | | |
| 15 | 35% LCP + 65% | 330 | 3.5 | 9476 (66.3 MPa) | 50 (1.27 μm) |
| | graphite | | | | |
| | fiber | | | | |

### Example 2

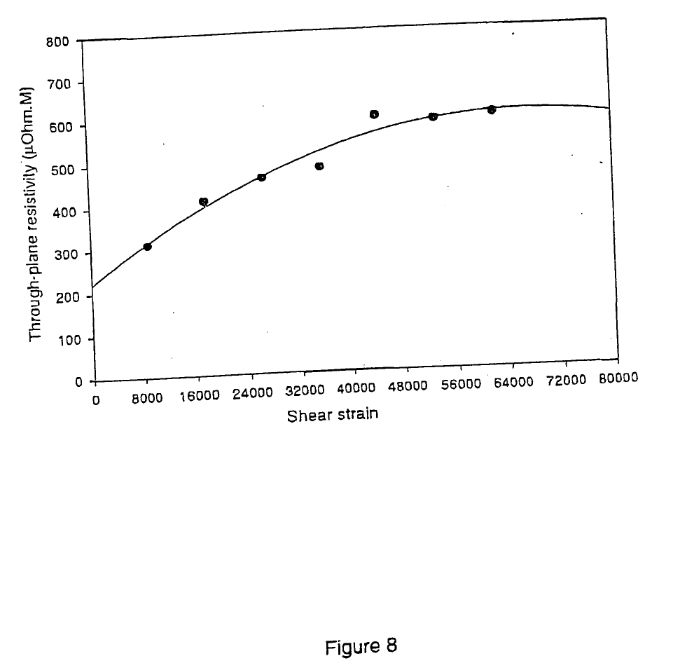

A composite formulation was dry blended with 25% (wt) of ground LCP powder resin, 55% (wt) of graphite powder and 20% (wt) graphite fiber in a tumbling blender at a room temperature of 25° C. to form a homogeneous mixture. The mixture was then compounded in a Brabender® mixer REE-6 at 320° C. temperature with different rotating speeds ranging from 20 to 140 rpm for 2 minutes each time. The mixture was then deposited homogeneously into a 4″×4″ (1 0. 16 cm×10.16 cm) flat mold cavity. The mold and the mixture was preheated at a Wabash hydraulic press to 320° C. and the mixture then pressed into a flat place of the size 4″×4″×1/10″ (10.16 cm×10.16 cm×0.25 cm) at a minimum but sufficient shear rate and pressure. The plate was then allowed to cool to room temperature. The different molded plates were then tested for through-plane resistivity. The results are presented in Table 2 below, and plotted in FIG. 8.

TABLE 2
Through-Plane Resistivity for Plates Made Using Varying Shear
Strain:

| Brabender ® | Mixing | | | Plate through-plane |
|---|---|---|---|---|
| Mixer speed | time | Shear rate | | resistivity |
| (RPM) | (S) | (1/S) | Shear strain | (μOhm · m) |
| 20 | 120 | 74 | 8880 | 310 |
| 40 | 120 | 148 | 17760 | 410 |
| 60 | 120 | 222 | 26640 | 460 |
| 80 | 120 | 296 | 35520 | 480 |
| 100 | 120 | 370 | 44400 | 595 |
| 120 | 120 | 444 | 53280 | 585 |
| 140 | 120 | 518 | 62160 | 595 |

Note:
Shear strain = shear rate multiplied by mixing time.

Although the present invention has been shown and described with respect to its preferred embodiments and in the examples, it will be understood by those skilled in the art that other changes, modifications, additions and omissions may be made without departing from the substance and the scope of the present invention as defined by the attached claims.

1. A process for fabricating an electrically conductive shaped article, the process comprising the process stages of:
(a) preparing one or more feeds of a plastic and conductive fillers;
(b) feeding the plastic and conductive fillers to a melt compounding stage wherein a homogeneous melt is obtained;
(c) transferring the homogeneous melt; and
(d) subjecting the homogeneous melt to a moulding process to produce the conductive shaped article;
wherein all of the process stages are conducted under low shear strain totalling less than 80000, preferably less than 60000, more preferably less than 30000, still more preferably less than 20000 and most preferably less than 10000.

2. The process of claim 1, wherein the shaped article has a through-plane resistivity of less than 600 μOhm-m.

3. The process of claim 1 or 2, wherein all of the process stages are performed under low shear strain conditions.

4. The process claimed in any one of claims 1-3, wherein the compounding and moulding stages are performed under low shear strain conditions.

5. The process claimed in any one of claims 1-3, wherein three of the process stages are performed under low shear strain conditions.

6. The process claimed in any one of claims 1-3, wherein two of the process stages are performed under low shear strain conditions.

7. The process claimed in any one of claims 1-6 wherein the plastic is selected from thermoplastic and elastomers.

8. The process claimed in claim 7, wherein the plastic is a melt-processable thermoplastic fluorine-containing polymer.

9. The process claimed in any one of claims 1-8, wherein the conductive fillers comprise graphite powder filler and fibre filler; and the graphite powder filler and fibre filler are blended into a homogeneous mixture, which is then fed to the melt compounding stage.

10. The process claimed in any one of claims 1-9, wherein the plastic and conductive fillers are separately fed into the compounding stage, with the plastic being fed first so that it is molten when the conductive fillers are fed into the compounding stage.

11. The process claimed in any one of claims 1-10, wherein the homogeneous melt is metered and transferred to the moulding stage.

12. The process claimed in any one of claims 1-11, wherein the melt is transferred directly to the moulding stage.

13. The process claimed in any one of claims 1-12, wherein the plastic is a thermoplastic polymer.

14. The process claimed in claim 13, wherein the thermoplastic polymer is an aromatic-polyester-based liquid crystalline polymer.

15. The process claimed in any one of claims 1-14, wherein the article is an electrically conductive flow field plate.

16. The process claimed in any one of claims 1-15, wherein the article comprises a composition comprising:
i. from 10 to 50% by weight, preferably from 15 to 30%, most preferably from 20 to 25%, of the plastic;
ii. from 10 to 70% by weight, preferably from 15 to 40%, most preferably from 20 to 30%, of a graphite fibre filler haying fibres with a length of from 15 to 500, preferably from 50 to 300, most preferably from 100 to 250, μm; and
iii. from 0 to 80% by weight, preferably from 10 to 60%, most preferably from 40 to 60%, of a graphite powder filler having a particle size of from 20 to 1500, preferably from 50 to 1000, most preferably from 100 to 500, μm.

17. An improved process for fabricating an electrically conductive shaped article, comprising the steps of:
(a) providing a plastic, a graphite fibre filler, and a graphite powder filler;
(b) separately feeding the plastic, graphite fibre and graphite powder into a low shear, mixing and extrusion device capable of providing low shear wherein the plastic is melted and the fibre and graphite fillers are each mixed with the molten plastic and then extruded into an extrudate; and
(c) subjecting the extrudate to a moulding process to produce the electrically conductive shaped article;
wherein all the steps are conducted under low shear strain of totalling less than 80000, preferably less than 60000, more preferably less than 30000, still more preferably less than 20000 and most preferably less than 10000.

18. The improved process of claim 17, wherein the article has a through-plane resistivity of less than 600 μOhm-m.

19. The improved process as claimed in claim 17 or 18, wherein the low shear strain mixing and extrusion is conducted in a twin-screw extruder or a reciprocating co-kneading compounding extruder.

20. The improved process as claimed in any one of claims 17-19, wherein the plastic is a thermoplastic polymer, preferably an aromatic-polyester-based liquid crystalline polymer.

21. An electrically conductive shaped article formed by the process of claims 1 or 17, wherein the plastic is a thermoplastic melt-processable resin, and the article has a through-plane resistivity of less than 600 μOhm-m.

22. The electrically conductive shaped article of claim 21, wherein the article comprises:
(a) from 10 to 50% by weighs preferably from 15 to 30%, most preferably from 20 to 25%, of the plastic;
(b) from 10 to 70% by weight, preferably from 15 to 40%, most preferably from 20 to 30%, of a graphite fibre filler having fibres with a length of from 15 to 500, preferably from 50 to 300, most preferably from 100 to 250, μm; and
(c) from 0 to 80% by weight, preferably from 10 to 60%, most preferably from 40 to 60%, of a graphite powder filler having a particle size of from 20 to 1500, preferably from 50 to 1000, most preferably from 100 to 500, μm.

23. The electrically conductive shaped article of claim 21 or 22, wherein the shaped article has a flexural strength of greater than 3000 psi (21 MPa), preferably greater than 4000 psi (28 MPa), most preferably greater than 6000 psi (42 MPa).

24. The electrically conductive shaped article of any one of claims 21-23, wherein the article is a conductive flow field separator plate.

25. The conductive plate as claimed in claim 24, wherein the plate has a surface roughness of not more than 100 micro inch (2.54 μm).

26. The conductive plate as claimed in claims 24 or 25, wherein the thermoplastic polymer is an aromatic-polyester-based liquid crystalline polymer.

27. The conductive plate as claimed in any one of claims 24-26, wherein the graphite powders include synthetic or natural graphite powders in the form of flakes or sphericals.

28. The conductive plate as claimed in any one of claims 24-27, wherein the graphite fibers includes pitch based or PAN based graphite fibers.
